(19) United States
(12) Patent Application Publication
(10) Pub. No.: US 2026/0336184 A1
(43) Pub. Date: Oct. 29, 2026

(54) POLYPROPYLENE-BASED THIN FILM

(71) Applicant: TORAY FILMS EUROPE, SAINT-MAURICE-DE-BEYNOST (FR)

(72) Inventors: Lucile GAMBUT-GAREL, LYON (FR); Alberto VAZ, SATHONAY-CAMP (FR)

(73) Assignee: TORAY FILMS EUROPE, SAINT-MAURICE-DE-BEYNOST (FR)

(21) Appl. No.: 19/484,179

(22) PCT Filed: May 24, 2024
(86) PCT No.: PCT/FR2024/050670

§ 371 Date: Nov. 13, 2025

(30) Foreign Application Priority Data
May 26, 2023 (FR) FR2305262

(51) Int. Cl. B29C 48/00; B29C 48/08; B29C 48/18; B29C 48/88; B29K 23/00

(52) U.S. Cl. CPC B29C 48/022; B29C 48/0018; B29C 48/08; B29C 48/18; B29C 48/9135; B29K 2023/12; B29K 2023/16; B29K 2995/0053; B29K 2995/0097

(57) ABSTRACT

A biaxially oriented film that includes a layer including at least one isotactic polypropylene having a degree of crystallinity that is greater than or equal to 80%, at least one hydrocarbon resin, and having a thickness of between 5 μm and 11 μm. Also a method for preparing the film and a package that includes the film.

### FIELD

This disclosure relates to the field of polymer-based films for packaging, in particular food packaging. More specifically, this disclosure relates to polypropylene-based films.

### BACKGROUND

Polymer-based films are widespread. However, their proliferation represents a major ecological issue. One way to reduce the environmental impact of polymer-based films is to reduce their thickness, as discussed in document EP 0712714.

The choice of the polymer that serves as the main component of a film is based on the film's intended use. Among the commonly used polymers, polypropylene occupies a significant place, in particular for food packaging. In order to make packaging recyclable, it has been necessary to reduce the thickness of plastic films in order to reduce their portion of the packaging.

However, reducing the thickness of a polymer-based film leads to a loss of mechanical properties; this is particularly true for polypropylene-based films. To compensate for the loss of mechanical properties, it has been proposed, for example, to modify the manufacturing process, for example as disclosed in U.S. Pat. No. 4,261,944.

A method for reducing the thickness of a polypropylene-based film has also been proposed. This method, described in JP 2003 191324 A, requires a high number of stretches, which cannot be applied to thinner films having a thickness of less than 15 μm, as such a thin film would break.

While the solutions proposed to date are generally satisfactory, the fact remains that further reducing the thickness of films and restoring the mechanical properties that allow flexibility in the possible uses of a film is a challenge that must be addressed in order to reduce the environmental impact while ensuring good quality packaging.

### SUMMARY

Two closely-linked objectives of the invention are to reduce the environmental impact of polymer-based films and to reduce their manufacturing costs.

Another objective is to obtain a thin polypropylene-based film providing sufficient mechanical properties for its use in various fields of application, particularly food packaging.

Thus, the primary objective of this invention is to obtain a polypropylene film having a maximum thickness of 11 μm and exhibiting at least one of the following properties:
P1—low shrinkage,
P2—high tensile strength,
P3—high elongation at break,
P4—moisture barrier,
P5—twist effect.

At least one of the above objectives is achieved by means of the invention, which relates to a biaxially oriented film comprising a layer comprising at least one isotactic polypropylene having a degree of crystallinity that is greater than or equal to 80%, at least one hydrocarbon resin, and having a thickness of between 5 μm and 11 μm.

The invention also relates to packaging, in particular food packaging, comprising the film described above.

### BRIEF DESCRIPTION OF THE DRAWINGS

FIG. 1 is a diagram of a three-layer film according to the invention.

FIG. 2 is a bar diagram of the elongation at break in the machine direction.

FIG. 3 is a bar diagram of the elongation at break in the transverse direction.

FIG. 4 is a bar diagram of the Young's modulus in the machine direction.

FIG. 5 is a bar diagram of the Young's modulus in the transverse direction.

FIG. 6 is a bar diagram of the shrinkage in the machine direction and in the transverse direction.

FIG. 7 is a semi-developed formula of an isotactic chain of propylene units of a portion of a polypropylene.

FIG. 8 is a set of three photos showing the difference between a twistable film, i.e. having a twist effect, and a non-twistable film.

### DEFINITIONS

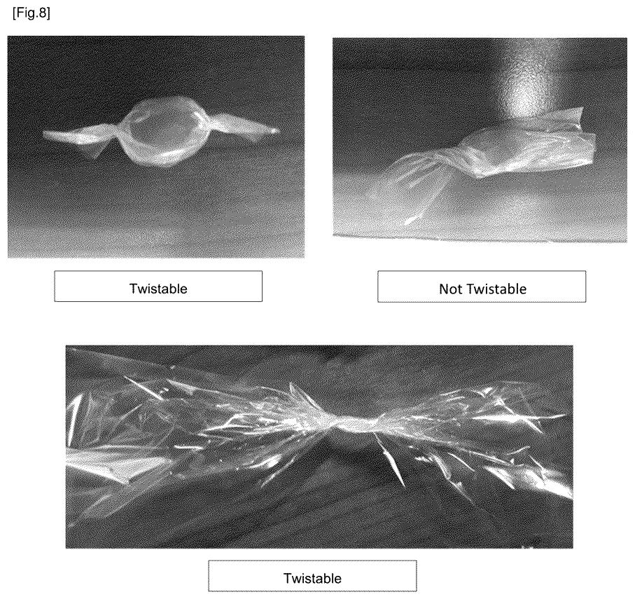

In the context of this invention, the terms below are understood to have the following meanings:
“resin” means a compound used in the manufacture of plastics. In practice, we refer to a resin as a polymer.
“isotactic polymer” means a polymer comprising an asymmetric carbon in its chain. In the case of polypropylene, if the methyl groups are all located on the same side of the plane represented by the polymer chain, then the polypropylene is isotactic, as illustrated in FIG. 7 (article by C. Duval on polypropylene in Techniques de l'Ingénieur, 2004).
“Degree of crystallinity” means the percentage of recurrences of the monomer units. It is measured according to the characterization method disclosed in WO 2022/00434 A1. The mesopentad fraction [mmmm] (unit in %) is measured by ¹³C NMR. The mesopentad fraction is measured according to the method described by Zambelli et al., “Macromolecules”, Vol. 6, p. 925 (1973). The ¹³C NMR measurement is performed by dissolving 200 mg of the polymer sample in an 8:2 (by volume) solution of o-dichlorobenzene and benzene at 135 °C.
“Twist effect” The property of retaining the twist applied to a film must be greater than 80%; a film exhibits a twist effect when the film is manually rotated 360° and less than 20% of the twist is lost, as shown in FIG. 8.

### DETAILED DESCRIPTION

### The Film

As mentioned above, the invention relates to a biaxially oriented film comprising a layer comprising at least one isotactic polypropylene having a degree of crystallinity that is greater than 80%, at least one hydrocarbon resin, and having a thickness of between 5 μm and 11 μm.

The film thickness is measured using a Mahr C1216 Millimar length measuring instrument with a P1300 flat probe. It should be noted that the film thickness is generally not exactly linear across the entire film. Indeed, due to the manufacturing processes, particularly during stretching, the surfaces of the film are not perfectly flat. This results in a variation in the film thickness with up to 0.6 μm of standard deviation in laboratory tests and up to 0.3 μm of standard deviation at an industrial scale.

### The Polypropylene

In the context of the invention, the polypropylene is isotactic and has a degree of crystallinity that is greater than 80%. Preferably, the polypropylene has a degree of crystallinity that is greater than 85%, more preferably greater than 90%, and even more preferably greater than 95%.

Advantageously, the polypropylene has a number-average molar mass of between 230,000 and 250,000, more advantageously between 240,000 and 250,000. The molar mass of the resins may be measured by high-temperature size exclusion chromatography, using trichlorobenzene as a solvent and infrared detection. The number and weight of the masses are then obtained, which give the macrostructure following the ISO 16014 standards.

While the polypropylene may have some branching, it is preferably linear.

### The Hydrocarbon Resin

The hydrocarbon resin is preferably selected from the group comprising, preferably consisting of, petroleum resins, terpene resins, styrene resins, cyclopentadiene resins, cyclononadiene resins, and mixtures thereof.

Advantageously, the hydrocarbon resin has a number-average molar mass of between 500 and 5000, more advantageously between 800 and 4000, and even more advantageously between 1000 and 3000.

The molar mass of the resins may be measured by size exclusion chromatography using a tetrahydrofuran solvent, a Waters column, and detection by differential refractometer. The number and weight of the masses are then obtained, which give the macrostructure.

The hydrocarbon resin makes it possible to prevent the formation of cracks in the layer of isotactic polypropylene having a degree of crystallinity greater than 80%.

### The Mass Ratio

The mass ratio of polypropylene to hydrocarbon resin depends on the degree of crystallinity of the polypropylene. The higher the degree of crystallinity of the polypropylene, the lower the ratio must be. Generally, the mass ratio of isotactic polypropylene to hydrocarbon resin is between 2.9 and 19. Preferably, the mass ratio of isotactic polypropylene to hydrocarbon resin is between 2.9 and 19, preferably between 2.9 and 10, and more preferably between 2.9 and 7.

### Structure of the Film

According to the invention, the film has a thickness of between 5 μm and 10 μm. Advantageously, the film has a thickness of between 6 μm and 9 μm, more advantageously between 6 μm and 8 μm.

The film according to the invention may further comprise a second layer. Preferably, the second layer comprises one or more polymers selected from the group comprising, preferably consisting of, ethylene polymers, maleic anhydride grafted polyethylenes, propylene polymers, ethylene-propylene copolymers, butylene-ethylene-propylene copolymers, heterophasic copolymers, butylene homopolymers, butylene copolymers, metallocene polymers, ethyl methacrylate (EMA) polymers, ethylene-vinyl acetate (EVA) polymers, and mixtures thereof.

The film may further comprise a third layer, identical to or different from said second layer. Preferably, the third layer comprises one or more polymers selected from the group comprising, preferably consisting of, ethylene polymers, maleic anhydride grafted polyethylenes, propylene polymers, ethylene-propylene copolymers, butylene-ethylene-propylene copolymers, heterophasic copolymers, butylene homopolymers, butylene copolymers, metallocene polymers, ethyl methyacrylate (EMA) polymers, ethylene-vinyl acetate (EVA) polymers, and mixtures thereof.

Thus, according to one embodiment of the invention, the film is a three-layer film having a structure A/B/C. Preferably, the layer comprising isotactic polypropylene and hydrocarbon resin is layer B.

Advantageously, the film is free of antistatic agents such as fatty acid esters. This embodiment is advantageous because fatty acid esters can be detrimental to the film's performance, particularly in terms of the oxygen barrier and moisture barrier when the film is metallized. Furthermore, films comprising fatty acid esters are difficult to recycle. This may also be extended to migrating products such as tertiary amines or fatty amides such as erucamide, which are used for their migration properties in order to have slip properties.

### Properties of the Film

The film according to the invention presents a compromise that allows its use in various fields of application. The properties of the film may be adjusted according to its intended use.

In particular, the film of the invention exhibits less shrinkage when maintained for 15 minutes at 140 °C than the shrinkage of a film formed with a standard resin. This shrinkage benefit, depending on the film formation process and the equipment used, is generally between 25% and 50% in the machine direction and between 40% and 60% in the transverse direction.

The film according to the invention exhibits an elongation at break in the machine direction that is greater than 180% and an elongation at break in the transverse direction that is greater than 45%.

The film according to the invention also has excellent tensile strength, greater than 12.5 daN/mm² in the machine direction and greater than 35 daN/mm² in the transverse direction.

The Young's modulus of the film according to the invention is greater than 290 daN/mm² in the machine direction and 690 daN/mm² in the transverse direction. The ratio M between the Young's modulus in the machine direction (MD) and the Young's modulus in the transverse direction (TD), according to the following equation 1:

M=Y(MD)/(Y(MD)+Y(TD) (equation 1)

is generally less than 0.35 and preferably between 0.2 and 0.35. This value of M corresponds to a window in the process that allows for a stable thin film (limiting breakage) with satisfactory mechanical and thermal properties.

Thus, the film according to the invention exhibits a balance between elasticity, mechanical strength, and thermal stability, providing great flexibility in the possible uses of said film while having the advantage of being thin. In particular, when the film according to the invention is used in a lamination process, or undergoes a treatment of metallization or of deposition of silicone or alumina, its properties, particularly barrier properties, are not or are only slightly degraded.

### Uses for the Film

The film may be used for various applications, but is particularly suitable for food use. Thus, the invention also relates to a food packaging comprising the film described above.

### Method for Preparing the Film

The film according to the invention is preferably prepared according to the following method:
E1: (co)extrusion including a matrix composed of 1 to 3 layers of the polymer(s) constituting each of the layers, to form a film web,
E2: quenching said film web, obtained in step E1, on a chill roll or cast roll, at a controlled temperature within the range of about 5 °C to 45 °C in order to solidify said film web, followed by a secondary cooling on another chill roll at a controlled temperature, to form a sheet,
E3: stretching said sheet, obtained in step E2, in the machine direction at about 95 °C to 165 °C, to a ratio of about 4 to 5.5 times the original length, to obtain a uniaxially oriented sheet,
E4: stretching said uniaxially oriented sheet, obtained in step E3, in the transverse direction at about 130 °C to 180 °C, to a ratio of about 7 to 10 times the original length, then heat-setting at about 100 and 200 °C, to obtain a biaxially oriented film.

### EXAMPLES

### Materials Used:

Polymer P1: Isotactic homopolymer with a degree of crystallinity of less than 60% according to the mesopentad method, a melt flow rate of 2.2 g/10 min at 230 °C under 2.16 kg, and a typical melting temperature of 232-274 °C.

Polymer P2: Isotactic homopolymer that is semi-crystalline at 60-80% according to the mesopentad method described above. The melt flow rate is 2 g/10 min at 230 °C and under 2.16 kg, and the typical melting temperature is 232-274 °C.

Polymer P3: Polymer with high crystallinity at 98% according to the mesopentad method, a melt flow rate of 2.0 g/10 min at 230 °C under 2.16 kg, and a softening point of 163 °C.

Polymer P4: C5 hydrocarbon polymer with polynorbornene at 60%, with a melt flow rate of 36 g/10 min at 190 °C under 2.16 kg and a softening point of 140 °C.

### Example 1: Film Preparation

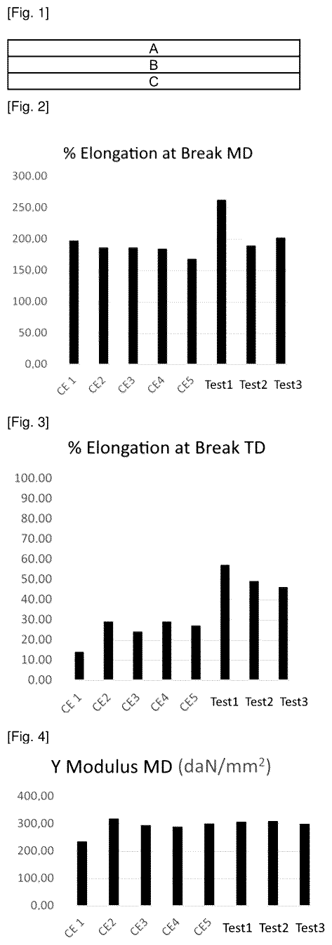

Eight films composed of three layers with an A/B/C structure (FIG. 1) were prepared according to the following protocol:
The three layers A, B and C are extruded, according to a coextrusion process including a matrix composed of three layers. The polymer core layer (B) is sandwiched between the outer skin layer (A) and the outer protective layer (C),
The outer layer (A) of a three-layer laminate sheet is cast onto a chill roll or cast roll at a controlled temperature within the range of about 15 °C to 45 °C in order to solidify the unoriented laminate sheet, followed by a secondary cooling on another temperature-controlled chill roll,
The unoriented laminate sheet is stretched in the machine direction at about 95 °C to 165 °C, to a ratio of approximately 4 to 5.5 times the original length, and is then heat-set at about 50 °C to 100 °C, to obtain a uniaxially oriented laminate sheet with minimal thermal shrinkage,
The uniaxially oriented laminated sheet is fed into a stenter and preheated to between about 130 °C to 180 °C, stretched in the transverse direction to a ratio of approximately 7 to 10 times the original length, and then heat-set to produce a biaxially oriented sheet with minimal thermal shrinkage.

Each of the eight films comprises the same layer A and layer C.

Layer A has a thickness of 0.7 μm and contains 49.4% by weight of polymer P1, 50% by weight of a resin comprising maleic anhydride units, and 0.6% by weight of a process control agent.

Layer C has a thickness of 1 μm and is composed of a polyethylene-polypropylene copolymer.

Each of the eight films has a different layer B as shown in Table 1 below:

TABLE 1

| Film | | | | | | | | |
|---|---|---|---|---|---|---|---|---|
| Polymer | E1 | E2 | E3 | CE1 | CE2 | CE3 | CE4 | CE5 |
| P1 | | | | 100 | | | | |
| (weight %) | | | | | | | | |
| P2 | | | | | 75 | 80 | 85 | 90 |
| (weight %) | | | | | | | | |
| P3 | 75 | 85 | 92.5 | | | | | |
| (weight %) | | | | | | | | |
| P4 | 25 | 15 | 7.5 | | 25 | 20 | 15 | 10 |
| (weight %) | | | | | | | | |

The thickness of each of the eight films was measured using a Mahr C1216 length measuring instrument with a P1300 flat probe. The results are listed in Table 2 below:

TABLE 2

| Film | E1 | E2 | E3 | CE1 | CE2 | CE3 | CE4 | CE5 |
|---|---|---|---|---|---|---|---|---|
| thickness | 9.7 | 10.4 | 10.5 | 9.3 | 9.9 | 9.7 | 10.1 | 10.0 |
| (μm) | | | | | | | | |

### Example 2: Measuring the Mechanical Properties of the Films

The elongation at break (EB), tensile strength (TS) and Young's modulus (YM) of each of the eight films were measured in the machine direction (MD) and transverse direction (TD) according to ASTM D882. The shrinkage (SH) of each of the eight films was also measured, in the machine direction (MD) and transverse direction (TD), on square 10 cm samples placed at 140 °C for 15 minutes. The results are listed in Table 3 below:

TABLE 3

| Film | direc- | | | | | | | | |
|---|---|---|---|---|---|---|---|---|---|
| | tion | E1 | E2 | E3 | CE1 | CE2 | CE3 | CE4 | CE5 |
| EB | MD | 262 | 189 | 202 | 197 | 186 | 186 | 184 | 168 |
| (%) | TD | 57 | 49 | 46 | 14 | 29 | 24 | 29 | 27 |
| TS | MD | 12.7 | 16.7 | 16.8 | 19.4 | 15.4 | 15.3 | 15.1 | 14.4 |
| (daN/ | TD | 35.2 | 37.1 | 43.3 | 24.1 | 31.6 | 32.4 | 33.7 | 34.9 |
| mm²) | | | | | | | | | |
| YM | MD | 307 | 309 | 298 | 235 | 318 | 294 | 288 | 300 |
| (daN/ | TD | 717 | 697 | 769 | 587 | 705 | 721 | 672 | 708 |
| mm²) | | | | | | | | | |
| SH | MD | 3.6 | 4.6 | 4.8 | 6.5 | 7.8 | 7.7 | 7.5 | 6.9 |
| (%) | TD | 2.6 | 4.2 | 6.7 | 8.3 | 7.2 | 8.3 | 8.3 | 7.5 |

The elongation at break in the machine direction (FIG. 2) is similar for films E2 and E3 as for films CE1, CE2, CE3 and CE4. However, by direct comparison, the elongation at break is much higher for film E1 than for film CE2, for film E2 than for film CE4, and for film E3 than for film CE5. Thus, replacing polymer P2 with polymer P3 allows a significant increase in the elongation at break in the machine direction.

In the transverse direction (FIG. 3), the elongation at break of films E1, E2 and E3 is much better than the elongation at break of films CE1 to CE5.

Thus, polymer P3, with its high crystallinity, allows improved elongation at break in both the machine and transverse directions, compared to polymer P2, which has moderate crystallinity.

Although the tensile strength is slightly lower for film E1 (lowest amount of polymer P3), film E1 exhibits acceptable tensile strength.

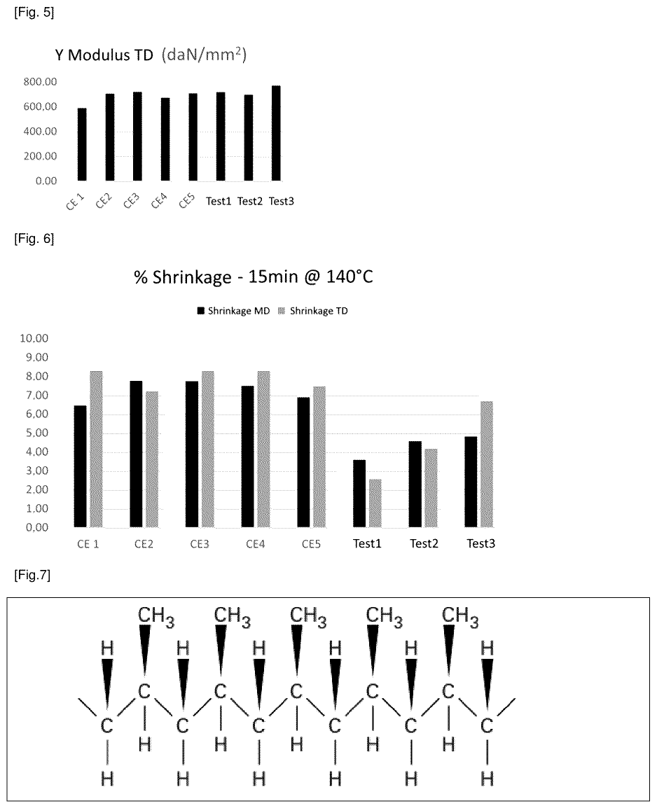

The Young's moduli of all films are similar, whether in the machine direction (FIG. 4) or in the transverse direction (FIG. 5). This means that their respective stiffnesses are similar. However, the increase in the degree of crystallinity by using polymer P3 instead of polymer P2 should be accompanied by an increase in stiffness and therefore in the Young's modulus. The combination with polymer P4, i.e. a hydrocarbon resin, makes it possible to obtain a better elongation at break for the films according to the invention (E1 to E3: Test1, Test2, Test3) than for the films outside the invention (CE1 to CE5) while maintaining good tensile strength and adequate stiffness.

In other words, the use of the combination of a high crystallinity polymer (polymer P3) and a hydrocarbon resin (polymer P4) in the proportions according to the invention makes it possible to obtain a thin film while retaining the elastic properties of the film.

Furthermore, the shrinkages (FIG. 6) of the films according to the invention (E1 to E3), whether in the machine direction or in the transverse direction, are much lower than the shrinkages of the films outside the invention (CE1 to CE5). This indicates that the films according to the invention are more thermally stable than the films outside the invention.

### Example 3: Moisture Barrier

The moisture barrier effect of each of the eight films was measured according to ASTM F1249. The results are listed in Table 4 below:

TABLE 4

| Film | E1 | E2 | E3 | CE1 | CE2 | CE3 | CE4 | CE5 |
|---|---|---|---|---|---|---|---|---|
| PH₂0 | 4.91 | 4.45 | 5.21 | 6.78 | 4.64 | 4.06 | 4.55 | 5.21 |
| (g.m⁻².24h⁻¹) | | | | | | | | |

Polypropylene films inherently have a good oxygen barrier. The hydrocarbon resin layer provides an improvement of about 1% over a polypropylene film not containing a hydrocarbon resin layer.

### Example 4: Influence of the Method of Preparation

The protocol detailed in Example 1 was reproduced with the same components as for films E1, E2 and E3, but the stretching in the machine direction was carried out to a ratio of approximately 6 to 8 times the original length.

All the films obtained in this example broke during stretching.

1-12. (canceled)

13. A biaxially oriented film comprising a layer comprising at least one isotactic polypropylene having a degree of crystallinity that is greater than or equal to 80%, at least one hydrocarbon resin, and having a thickness of between 5 μm and 11 μm.

14. The film according to claim 13, wherein the film having a ratio M, between the Young's modulus in the machine direction (MD) and the Young's modulus in the transverse direction (TD), according to the following equation 1:
M=Y(MD)/(Y(MD)+Y(TD) (equation 1)
that is less than 0.35.

15. The film according to claim 13, wherein the isotactic polypropylene and the hydrocarbon resin are present at a mass ratio of isotactic polypropylene to hydrocarbon resin of between 2.9 and 19.

16. The film according to claim 13, further comprising a second layer comprising one or more polymers selected from the group consisting of ethylene polymers, maleic anhydride grafted polyethylenes, propylene polymers, ethylene-propylene copolymers, butylene-ethylene-propylene copolymers, heterophasic copolymers, butylene homopolymers, butylene copolymers, metallocene polymers, ethyl methacrylate (EMA) polymers, ethylene-vinyl acetate (EVA) polymers, and mixtures thereof.

17. The film according to claim 16, further comprising a third layer, identical to or different from said second layer, comprising one or more polymers selected from the group consisting of ethylene polymers, maleic anhydride grafted polyethylenes, propylene polymers, ethylene-propylene copolymers, butylene-ethylene-propylene copolymers, heterophasic copolymers, butylene homopolymers, butylene copolymers, metallocene polymers, ethyl methacrylate (EMA) polymers, ethylene-vinyl acetate (EVA) polymers, and mixtures thereof.

18. The film according to claim 13, wherein the hydrocarbon resin has a number-average molar mass of between 500 and 5000, by size exclusion.

19. The film according to claim 13, wherein the hydrocarbon resin is selected from the group consisting of petroleum resins, terpene resins, styrene resins, cyclopentadiene resins, cyclononadiene resins, and mixtures thereof.

20. The film according to claim 13, wherein said degree of crystallinity is greater than or equal to 85%.

21. The film according to claim 13, wherein the film has a thickness of between 6 μm and 9 μm.

22. The film according to claim 13, wherein when said film is maintained for 15 min at 140 °C, said film exhibits less shrinkage than the shrinkage of a film formed with a standard resin.

23. A packaging comprising the film according to claim 13.

24. A method for preparing a film according to claim 13, comprising the following successive steps:
E1: (co)extrusion including a matrix composed of 1 to 3 layers of the polymer(s) constituting each of the layers, to form a film web,
E2: quenching said film web, obtained in step E1, on a chill roll or cast roll, at a controlled temperature within the range of 5 °C to 45 °C in order to solidify said film web, followed by a secondary cooling on another chill roll at a controlled temperature, to form a sheet,
E3: stretching said sheet, obtained in step E2, in the machine direction at 95 °C to 165 °C, to a ratio of 4 to 5.5 times the original length, to obtain a uniaxially oriented sheet, and
E4: stretching said uniaxially oriented sheet, obtained in step E3, in the transverse direction at 130 °C to 180 °C, to a ratio of 7 to 10 times the original length, then heat-setting at 100 °C to 200 °C, to obtain a biaxially oriented film.
